(19) United States
(12) Patent Application Publication
(10) Pub. No.: US 2012/0196073 A1
(43) Pub. Date: Aug. 2, 2012

(54) Method of manufacturing a covering panel with a profiled edge

(75) Inventors: Bruno Paul Louis Vermeulen, Aldeneik-Maaseik, MN (US); Jan Eddy De Rick, Geraardsbergen (BE)

(73) Assignee: Spanolux N.V.-Div. Balterio, Sint-Baafs-Vijve (BE)

(21) Appl. No.: 13/393,680

(22) PCT Filed: Sep. 1, 2010
(86) PCT No.: PCT/EP10/62810

§ 371 Date: Apr. 17, 2012

(30) Foreign Application Priority Data
Sep. 1, 2009 (EP) 09169177.4
Feb. 9, 2010 (EP) 10153036.8

(51) Int. Cl. B32B 3/06; B26D 7/10

(52) U.S. Cl. 428/60; 83/15; 83/170

(57) ABSTRACT

A method and system of manufacturing a panel, such as a vinyl floor tile, with one or more profiled edges, wherein the edge is moved along one or more machining tools to form the profiled edge wherein the panel is cooled at least in an area containing the edge, wherein the cooling takes place before and/or during machining of the edge. Covering element manufactured this way, comprising at least one profiled edge at least partly within a thermoplastic section, the edge being profiled to form a tongue-in-groove interlocking connection with a matching profiled edge of a corresponding covering element.

### CROSS-REFERENCE TO RELATED APPLICATION

This application is a Section 371 National Stage Application of International Application PCT/EP2010/062810 filed Sep. 1, 2010 and published as WO/2011/026864 in English.

### BACKGROUND

The discussion below is merely provided for general background information and is not intended to be used as an aid in determining the scope of the claimed subject matter.

Aspects of the present invention relate to a method of manufacturing a panel, such as a vinyl tile or floor covering panel, comprising profiled edges, in particular for forming an interlocking connection with adjacent floor covering panels or tiles. The interlocking connection can for example be a snap-fit connection, an angling connection or a push-down, fall-down or fold-down connection or the like.

To enhance users comfort, vinyl floor tiles or covering panels generally comprise plasticizers to soften the vinyl material. The manufacture of floor tiles using such soft materials is typically done by injection molding to obtain the tight dimensional tolerances required for interlocking snap-fit or angling connections. To provide interlocking elements complicated non-releasing die constructions must be used. The interlocking elements must be designed to have a more or less uniform wall thickness to prevent internal stresses resulting from uneven cooling.

Other type of floor panels, such as wood laminates, are often manufactured with profiled edges providing tongue in groove connections or similar snap-fit or angling connections made by machining. Such click-in connections can be easily realized by end-users, without the need for professional skills, and are particularly suitable for the do-it-yourself market. The edges are moved along the machining tools with high speed. Hitherto, it was believed that such a manufacturing method would technically and economically not be feasible for manufacturing vinyl tiles or panels or panels of a resiliency comparable to vinyl, since the material is relatively soft and elastic and has a high shear modulus. As a consequence, more driving power would be required to move the work piece along the machining tool and the tools would wear out considerably faster than with other type of floor covering materials. When the panels are moved along the machining tools, they can be pushed by one or more cams on the conveyor or, if so desired, they can be kept in place by positioners, such as a skid or a clamp head. The forces applied by the machining tools or by such cams and/or positioners and clamps can deform the soft and resilient thermoplastic material, which results in dimensional deviations in the profiled edge. The resiliency of the material and the deformation effects are further increased by heat generated by the machining tool. Moreover, during machining thermoplastic materials are statically charged, which results in sticking of released sawdust.

It has been proposed to apply vinyl layers on a carrier layer of a machinable material, such as wood laminate. The interlocking profile is then machined into the edge of the carrier layer. However, this increases the material costs as well as the costs of manufacturing.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

An aspect of the invention provides a cost efficient manufacturing method for panels of a resilient material, such as thermoplastic or vinyl tiles, providing sufficient freedom of design to dimension a firm but releasable interlocking connection with tight tolerances without expensive dies and with only limited wear of machining tools.

A method of manufacturing a panel with one or more profiled edges includes moving the edge along a machining tool to form the profiled edge wherein the panel is cooled at least in an area containing the edge before and or during machining of the edge.

It has been found that this way covering elements can be manufactured providing firm and gap-free interlocking connections, such as tongue-in-groove connections, with much less wear of the machining tools.

The panel can for example be made of a thermoplastic material, such as a vinyl, optionally comprising a plasticizer. Alternatively, the panel can be made of any other suitable resilient material, having a resiliency comparable to the resiliency of plasticized vinyl or have a resiliency which is higher than the resiliency of a wood laminate, such as for example cork.

Thermoplastic materials are characterized by a softening temperature or temperature range. Below the softening temperature, the material is considerably more stiff than above the softening temperature. It has been found that the manufacturing method works particularly well if the work piece, or at least the edge area to be profiled, is cooled to the softening temperature of the thermoplastic material, e.g., within a softening temperature range or lower.

The profiled edge may have a configuration requiring machining in two or more steps. In such a case, the area containing the edge can be cooled between two successive steps, e.g., between all steps.

The panel can for instance be cooled in a cooling chamber or cooling tunnel, e.g., cooling tunnels as generally used in food industry, before being machined. Alternatively, or additionally, the panel can be cooled using a cooling medium, such as liquefied carbon dioxide, liquefied nitrogen, dry ice, or similar substances.

Due to the cooling of the edge area of the panel, the tendency of sawdust to stick to the panel and/or to the machine as a result of static charge during machining is substantially reduced. Further reduction of static charge effects can be achieved by creating a conductive environment, e.g., by increasing ambient air humidity.

It is thus possible to manufacture a covering element, such as a floor tile or wall panel, which is at least partly made of a thermoplastic material, wherein the covering element comprises at least one profiled edge within a thermoplastic section of the covering element, the edge being profiled to form a tongue-in-groove interlocking connection with a profiled edge of a corresponding tile.

Such interlocking systems have been used for floor laminates but hitherto it was not possible to manufacture thermoplastic floor tiles this way with the required tight tolerances.

A specific embodiment comprises a method of manufacturing a panel with one or more profiled edges, wherein the edge is moved along one or more machining tools to form the profiled edge wherein the panel is cooled at least in an area containing the edge, wherein the edge to be profiled is at least partly made of a thermoplastic material and the area of the edge is cooled to the softening temperature of the thermoplastic material or lower, wherein the cooling takes place at least before machining of the edge so as to reduce deformation effects during machining of the edge. The advantage of cooling the edge before machining is that cooling of the edge or the tools during machining may be less critical or even omitted. If machining is performed in a relatively hot environment it is advantageous to keep the time period between cooling and machining as short as possible so as to avoid warming-up of the edge before machining.

It is noted that the panel as described hereinbefore may be a floor panel of which the profiled edge is intended to form part of an interlocking connection with a matching profiled edge of a corresponding panel. This means that the machining operation may be more complex than only removing a thin edge portion of a panel, for example in case of a groove and tongue profile.

The covering element can for example be a multi-layer panel comprising at least one layer of a thermoplastic material, e.g. a vinyl material comprising a plasticizer. The covering element can for example be provided with a protective abrasion resistant top layer, e.g. of a polyurethane material. Optionally, one of the layers can be a foam layer and/or a rigid carrier layer, such as an HDF layer. The interlocking profile can then be machined from the thermoplastic material only or partly from the thermoplastic material and partly from the carrier layer.

### BRIEF DESCRIPTION OF THE DRAWINGS

Aspects of the present invention will be elucidated with reference to the figures wherein:

FIG. 1: shows schematically a vinyl tile in a processing station;

FIG. 2: shows two interlocked vinyl floor tiles manufactured;

FIG. 3A: shows schematically a vinyl tile in a processing station without cooling;

FIG. 3B: shows the vinyl tile of FIG. 3A being manufactured.

### DETAILED DESCRIPTION OF THE ILLUSTRATIVE EMBODIMENT

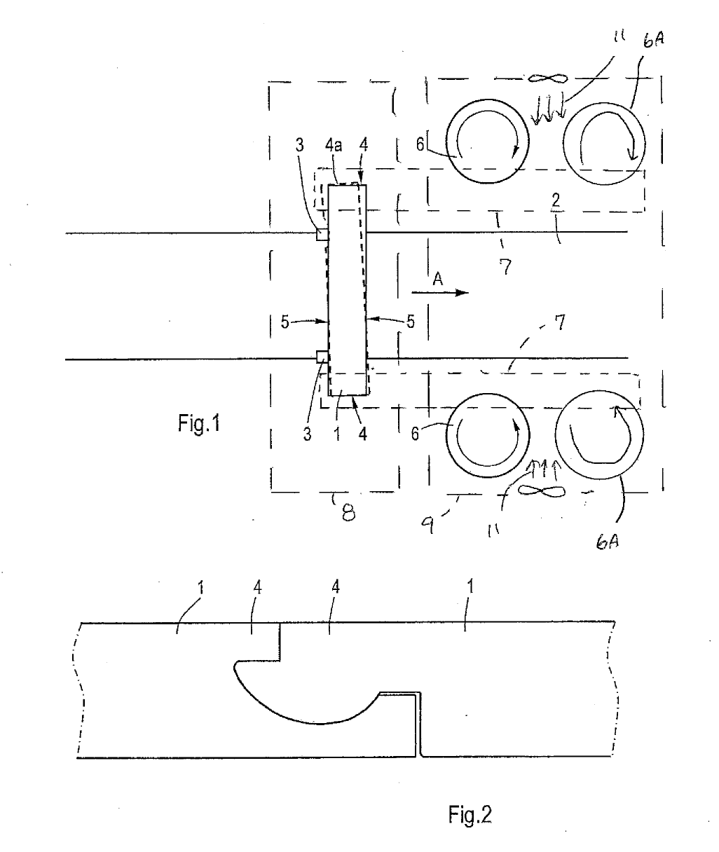

FIG. 1 shows a vinyl floor covering element (panel) 1 on a conveyor 2 moving in direction A. The vinyl floor covering element 1 is pushed forward by two cams 3 moving with the conveyor 2. The covering element 1 comprises two opposite short edges 4 and two opposite long edges 5 forming a longitudinal rectangular body. Two machining tools 6 are positioned at opposite sides of the conveyor 2. The vinyl floor covering element 1 is positioned on the conveyor 2 in such a way that the short edges 4 are moved along the working scope of the machining tools 6 so as to form a suitable profile for a click-in connection. The broken line shows the possible deformation of the covering element 1 if the element 1 is not manufactured using aspects of the invention, due to the forces exerted by the machining tools 6 and the cams 3. The solid line shows the outline of the element 1 if it is cooled before passing the machining tools 6. The element 1 can be cooled in its entirety (represented schematically by area 8, which can be a cooling chamber or cooling tunnel) or the edges 4 can be cooled locally (represented schematically by areas 7), e.g., by means of dry ice. Since the element 1 is not deformed, the desired edge profile can be machined with much more accuracy and tighter tolerances and the machining tools are exposed to much less wear, and an effective interlocking profile can be obtained with high accuracy and tight tolerances providing a gap-free connection as for example is shown in cross section in FIG. 2.

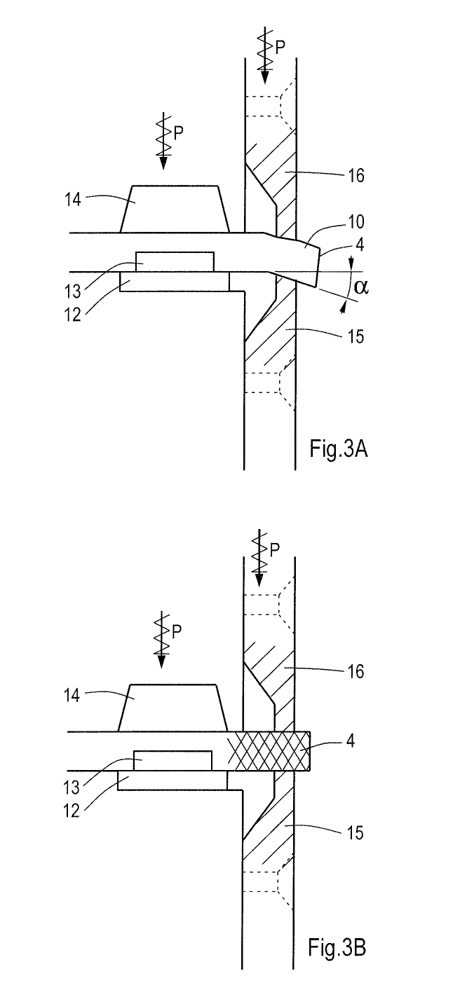

FIG. 3A shows in cross section a vinyl tile 10 being machined without being cooled. FIG. 3B shows the same situation when the vinyl floor tile 10 is machined according to aspects of the present invention. The tile 10 is placed on a conveyor 12 and pushed forward by a cam 13 moving with the conveyor 12. A pusher belt 14 clamps the vinyl tile 10 in its position on the conveyor 12. When the panel 1 approaches a cutting tool, the panel 1 slides between a skid or slip shoe 15 and a pressure shoe 16 pinching the area 4 of the edge to be profiled. The pressure shoe 16 exerts a force P onto the edge 4 to be profiled. As a result, the edge 4 bends and cannot be accurately profiled anymore. In FIG. 3B the cross hatched edge area 4 was cooled below the softening temperature of the vinyl material. As a result, the edge area 4 withstands the force P exerted by the pressure shoe 16 without bending. A more accurate cut can be made with a machining tool (not shown). The used machining tool will be exposed to less wear.

The machining tools 6 and/or the conveyor 12 and/or the cam 13 and/or the pusher belt 14 may be cooled, as well (as represented schematically by areas 8 and 9). This prevents the floor covering element 1 from being in contact with any hot spot before and/or during machining of the edge. When the machining tools 6 are cooled the edge profile can be machined more accurately since the increase of the local temperature at the edge and the tools 6 during machining is minimized. Furthermore, the tendency of sawdust to stick to the tools 6 during machining is minimized. The machining tools 6 can be cooled by cooling ventilation air 11 which is directed to the machining tools 6 and exhausted therefrom, for example via a chimney located close to the machining tools. Cooling of the parts as mentioned hereinbefore can be done by water, air, nitrogen, or the like. The profiled edge 4 may have a configuration requiring machining in two or more steps (represented by tools 6 and 6A). In such a case, the area 8 containing the edge 4 can be cooled between two successive steps, e.g., between all steps.

1. A method of manufacturing a panel with one or more profiled edges, comprising moving the edge along one or more machining tools to form the profiled edge and cooling the panel at least in an area containing the edge, wherein the cooling takes place before and/or during machining of the edge.

2. The method according to claim 1 wherein the edge to be profiled is at least partly made of a thermoplastic material.

3. The method according to claim 2 wherein the thermoplastic material comprises a plasticizer.

4. The method according to claim 2 wherein the area of the edge is cooled to a softening temperature of the thermoplastic material or lower.

5. The method according to claim 1 wherein the profiled edge is machined in two or more steps and wherein the area containing the edge is cooled between two successive steps.

6. The method according to claim 1 wherein the panel is cooled in a cooling chamber or cooling tunnel before being machined.

7. The method according to claim 1 wherein the panel is cooled using a cooling medium, such as dry ice, liquefied carbon dioxide, liquefied nitrogen.

8. The method according to claim 1 wherein before or during machining the humidity of the ambient air is increased.

9. The method according to claim 1 wherein the machining tools are cooled before and/or during machining of the edge.

10. The method according to claim 9, wherein ventilation air which is directed to the machining tools and exhausted therefrom is cooled.

11. The method according to claim 1 wherein a transport transport a panel to the machining tools which contact the panel before and/or during machining are cooled before and/or during machining of the edge.

12. A method of manufacturing a panel with one or more profiled edges, comprising moving the edge along one or more machining tools to form the profiled edge and cooling the panel at least in an area containing the edge, wherein the edge to be profiled is at least partly made of a thermoplastic material and the area of the edge is cooled to a softening temperature of the thermoplastic material or lower, wherein the cooling takes place at least before machining of the edge so as to reduce deformation effects during machining of the edge.

13. The method according to claim 1 wherein the panel is a floor panel and the profiled edge is intended to form part of an interlocking connection with a matching profiled edge of a corresponding panel.

14. A covering element at least partly made of a resilient material, wherein the covering element is manufactured according to claim 1, and wherein the covering element comprises at least one profiled edge at least partly within a thermoplastic section of the covering element, the edge being profiled to form a tongue-in-groove interlocking connection with a matching profiled edge of a corresponding covering element.

15. The covering element according to claim 14 wherein the resilient material is a thermoplastic material, such as a vinyl material, optionally comprising a plasticizer.

16. The covering element according to claim 14 wherein the element is a multi-layer panel comprising at least one layer of a thermoplastic material.

17. A panel processing system, comprising:
a thermoplastic panel;
a machining tool to cut the thermoplastic panel;
a transport device supporting the thermoplastic panel and configured to bring the thermoplastic panel to and away from the machining tool; and
a cooling chamber cooling at least an edge of the thermoplastic panel to a softening temperature of the thermoplastic material.
